(19) United States
(12) Patent Application Publication
(10) Pub. No.: US 2024/0296456 A1
(43) Pub. Date: Sep. 5, 2024

(54) SYSTEMS AND METHODS FOR SECONDARY PAYMENT VEHICLE RULES

(71) Applicant: Vantiv, LLC, Symmes Township, OH (US)

(72) Inventor: Jackson Andrew UNRAU, Littleton, CO (US)

(21) Appl. No.: 15/656,605

(22) Filed: Jul. 21, 2017

(51) Int. Cl. G06Q 20/40

(52) U.S. Cl. CPC G06Q 20/405; G06Q 20/20; G06Q 20/2295

(57) ABSTRACT

A method for establishing secondary payment vehicle rules includes selecting a secondary payment vehicle, creating a new secondary payment vehicle rule, selecting a first rule type from among a plurality of allowed rule types including: designating merchant types at which the secondary payment vehicle may be used, designating merchant types at which the secondary payment vehicle may not be used, and specifying financial limits on a transaction; and establishing the new secondary payment vehicle rules. A method for applying secondary payment vehicle rules includes receiving a payment authorization request associated with a secondary payment vehicle from a requestor, determining whether the payment request is allowed by rules associated with the secondary payment vehicle, upon determining that the payment request is allowed by the rules, approving authorization of the request, otherwise, declining authorization of the request; and returning an authorization response to the requestor.

### TECHNICAL FIELD

The present disclosure relates generally to the field of consumer payment transactions and, more particularly, to setting and applying rules for use of a secondary payment vehicle linked to a primary account owner's account.

### BACKGROUND

In a typical scenario, a consumer may use a payment vehicle, such as a payment card, to complete transactions with a merchant, whether in person, by telephone, or online, etc. The consumer may also provide an additional payment vehicle for use by other individuals, organizations, businesses, etc. Such a “secondary payment vehicle” may be linked to the same source of funds as the consumer's primary payment vehicle or may draw from a separate source of funds.

However, the consumer would not be able to control how a secondary payment vehicle would be used, and so would be open to fraud and abuse by a user of the secondary payment vehicle. For example, the secondary payment vehicle may be used for purposes, or at times, or in locations, or with a frequency other than what the consumer intended or authorized. These unauthorized uses may cause the consumer to suffer a loss of funds, increased liability, damaged credit ratings, etc.

Accordingly, there is a need for systems and methods for setting and applying rules associated with a secondary payment vehicle so that a consumer authorizing the secondary payment vehicle may control the uses of the secondary payment vehicle with respect to the purposes for which it is used, the times of use, the location of use, the frequency of use, etc.

### SUMMARY

According to certain aspects of the present disclosure, systems and methods are disclosed for secondary payment vehicle rules.

In one embodiment, a computer-implemented method is disclosed for establishing secondary payment vehicle rules. The method includes: selecting a secondary payment vehicle for which rules will be created, creating a new secondary payment vehicle rule, selecting a first rule type from among a plurality of allowed rule types, the plurality of allowed rule types including: designating one or more merchant types at which the new secondary payment vehicle may be used, designating one or more merchant types at which the new secondary payment vehicle may not be used and specifying financial limits on a transaction processed using the new secondary payment vehicle; and establishing the new secondary payment vehicle rules for the selected secondary payment vehicle.

In one embodiment, a computer-implemented method is disclosed for applying secondary payment vehicle rules secondary payment vehicle rules. The method includes: receiving a payment authorization request associated with a secondary payment vehicle from a requestor, determining whether the payment request is allowed by one or more rules associated with the secondary payment vehicle, upon determining that the payment request is allowed by one or more rules associated with the secondary payment vehicle, approving authorization of the payment authorization request. Otherwise, declining authorization of the payment authorization request; and returning an authorization response to the requestor.

In accordance with another embodiment, a system is disclosed for applying secondary payment vehicle rules. The system comprises: a memory having processor-readable instructions stored therein; and a processor configured to access the memory and execute the processor-readable instructions, which when executed by the processor configures the processor to perform a plurality of functions, including functions to: receive a payment authorization request associated with a secondary payment vehicle from a requestor, determine whether the payment request is allowed by one or more rules associated with the secondary payment vehicle, upon determining that the payment request is allowed by one or more rules associated with the secondary payment vehicle, approve authorization of the payment authorization request, otherwise, decline authorization of the payment authorization request; and return an authorization response to the requestor.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the detailed embodiments, as claimed.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts a merchant environment for processing consumer payment transactions, according to one or more embodiments.

FIG. 2 depicts an alternative merchant environment for processing consumer payment transactions, according to one or more embodiments.

FIG. 3 is a flowchart depicting an example process for creating a secondary payment vehicle, according to one or more embodiments.

FIG. 4 is a flowchart depicting an example process for creating secondary payment vehicle rules, according to one or more embodiments.

FIG. 5 is a flowchart depicting an example process for adding funds to a secondary payment vehicle, according to one or more embodiments.

FIG. 6 is a flowchart depicting an example process for applying secondary payment vehicle rules, according to one or more embodiments.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of systems and methods disclosed herein for secondary payment vehicle rules.

As described above, a consumer providing a secondary payment vehicle for use by other individuals, organizations, businesses, etc., may be open to fraud and abuse by a user of the secondary payment vehicle. Thus, the embodiments of the present disclosure are directed to systems and methods for setting and applying rules associated with a secondary payment vehicle so that a consumer authorizing the secondary payment vehicle may control the uses of the secondary payment vehicle.

For simplicity, the description that follows will be provided by reference to a “payment vehicle” or a “payment card,” which generally refers to any type of alternative to currency. As is to be clear to those skilled in the art, no aspect of the present disclosure is specifically limited to a specific type of payment vehicle or payment card. Therefore, it is intended that the following description encompasses the use of the present disclosure with many other forms of financial alternatives to currency, including credit cards, debit cards, smart cards, single-use cards, prepaid cards, electronic currency (such as might be provided through a cellular telephone or personal digital assistant), and the like. Payment vehicles or payment cards can be traditional plastic transaction cards, titanium-containing, or other metal-containing, transaction cards, clear and/or translucent transaction cards, foldable or otherwise unconventionally sized transaction cards, radio-frequency enabled transaction cards, or other types of transaction cards, such as credit, charge, debit, prepaid or stored-value cards, electronic benefit transfer cards, or any other like financial transaction instrument.

Merchants use payment platforms, such as Point of Sale (“POS”) terminals and POS systems, to accept payments from consumers in the form of cash, check, credit cards, and so forth. Although POS terminals and POS systems are the most common type of payment platforms, the term “payment platform” as used herein is intended to be construed broadly and would include systems for coupon redemption, and systems for implementing frequent use programs or consumer loyalty programs, among other suitable transaction-based systems that involve certification of their ability to correctly process transactions with other systems. Nonlimiting examples of transaction-based systems could also include payment facilitators, ecommerce systems, mobile platforms, non-terminal POS solutions, and software solutions, such as those developed by independent software vendors, among other suitable transaction-based systems.

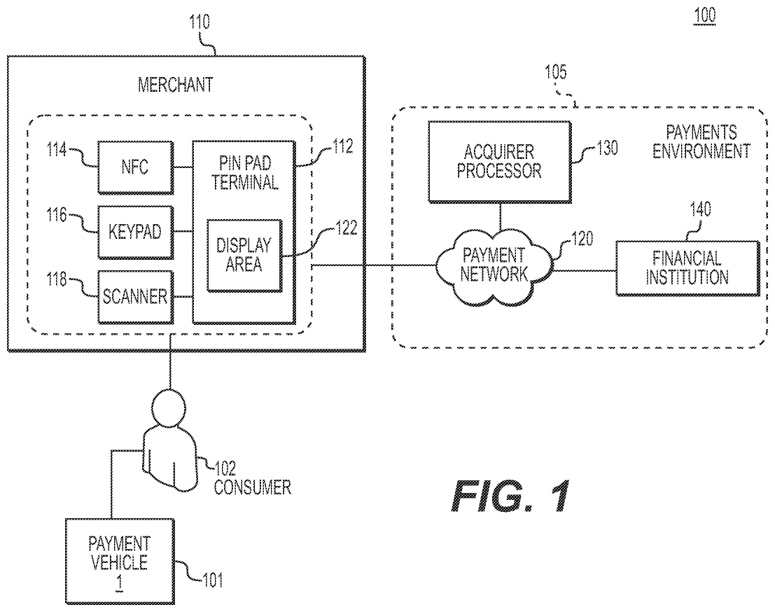

One or more examples of these non-limiting embodiments are illustrated in the selected examples disclosed and described in detail with reference to FIGS. 1-6 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

In some circumstances, a consumer, who may be a primary account holder, may wish to provide a secondary payment vehicle use by another consumer, which may be a spouse, child, business, organization, or any other consumer, who may be considered a secondary account holder. For example, the primary account holder may provide a secondary payment vehicle for use by a child attending college in order to pay school and living expenses. However, the primary account holder may wish to limit the uses of the secondary payment vehicle to certain types of merchants (book stores, restaurants, university expenses, etc.), to expenses below a specified limit (for example, a change of more than $100 may require further authorization), to a specified geographic area such as, for example, within 20 miles of the university, or to a specified number of transactions within a specified period such as, for example, ten transactions within one day. Other types of rules may be specified or rules may be specified in combination such as a cap of $500 per transaction at the university bookstore. Embodiments described in detail below may provide for such rules to be applied to a secondary payment vehicle.

Turning to FIG. 1, in a typical scenario, a merchant environment 100 for processing consumer payment transactions, according to one or more embodiments, may include a merchant 110, an acquirer processor 130, a financial institution 140, and first consumer 102, which may be provided in communication with each other via a payment network 120. The components of the payments processing network may be connected by any combination of wired or wireless networks, for example, PSTNs and/or the Internet. Acquirer processor 130 (e.g., acquiring bank) may be in partnership with payment network 120, such that the acquirer processor 130 may process payments through, and on behalf of, payment network 120. Payment network 120 may in turn have a partnership with financial institution 140 (e.g., issuing bank). Financial institution 140 may hold accounts for one or more consumers 102. Consumer 102 may have a payment vehicle 101 (e.g., credit card, debit card, stored value card, etc.) which may be affiliated with payment network 120. Consumer 102 may be able to use their payment vehicle 101 to make purchases with merchant 110.

Acquirer processor 130 may be an entity that provides a variety of electronic payment processing services to merchant 110. For example, acquirer processor 130 may be an entity that receives payment information from a transaction that occurs at a pin pad terminal 112 of merchant 110. The payment information may be, for example, payment card information encoded in the magnetic stripe or EMV chip of payment vehicle 101 and a payment amount of a transaction being made by, for example, consumer 102 with merchant 110 using the payment card account associated with payment vehicle 101. Acquirer processor 130 may process the information, and may send the information to the consumer's respective financial institution 140 via an appropriate payment network 120 depending on the particulars of payment vehicle 101. Processing the information may include, for example, determining the identity of payment network 120 and financial institution 140 associated with the particular payment vehicle 101.

Acquirer processor 130 may also receive information from payment network 120, such as confirmation or rejection of an attempted transaction using payment vehicle 101, and may convey that information to the appropriate POS terminal. Moreover, acquirer processor 130 may provide security and/or encryption services to merchant 110 and payment network 120, such that payments processed at pin pad terminal 112 may be completed with a decreased risk of data or financial theft or loss. Acquirer processor 130 may be located, for example, at a remote location from merchant 110 that uses its services, and may, for example, interact with merchant 110 primarily over an electronic network, such as a data network or the Internet.

Payment network 120 may be, for example, a network that relays debit and/or credit transactions to and from various accounts at financial institution 140. For example, payment network 120 may have a partnership program with financial institution 140 through which financial institution 140 may provide a payment vehicle account to consumer 102 associated with payment network 120. Payment network 120 may also be partnered with acquirer processor 130, which may manage payment transactions associated with payment network 120. Examples of payment network brands include, e.g., Visa, MasterCard, Discover, and American Express. While a single payment network 120 is illustrated, it is to be appreciated that multiple payment networks may be partnered with a single or multiple acquirer processors.

Financial institution 140 may be a bank that manages payment accounts associated with one or more payment networks 120 on behalf of one or more consumers 102. For example, financial institution 140 may allow for consumer 102 to build up a revolving credit balance at financial institution 140 and may periodically receive payments from consumer 102 to pay down the balance. Consumer 102 may be an individual, a company, or other entity having accounts with one or more financial institutions 140. Each consumer 102 may generally have at least one payment vehicle 101 associated with each payment account held by that consumer. Each consumer 102 may have multiple accounts with multiple financial institutions 140, which may be affiliated with the same or different payment networks 120.

Merchant 110 may be a merchant offering goods and/or services for sale to consumer 102 who have contracted with acquirer processor 130. Merchant 110 may be equipped with POS device , which is configured to receive payment information from payment vehicle 101 and to relay received payment information to acquirer processor 130. Merchant 110 can be any type of merchant, such as a brick-and-mortar retail location or an e-commerce/web-based merchant with a POS device or a web payment interface.

In FIG. 1, consumer 102 is shown to be associated with a payment vehicle 101. As is to be appreciated, payment vehicle 101 can include any type of payment vehicle that can be utilized to initiate a payment transaction. Unless otherwise specified herein, “payment vehicle” includes a virtual card, such as a display or screenshot for a mobile phone or for another portable device (e.g., a flash drive, smart chip, a laptop or portable computer), or for a computer device (e.g., a desktop computer) in combination with data indicative of an account number or other account indicative information. Data associated with the cards may include an encrypted or unencrypted account number or other encrypted or unencrypted account indicative information and/or encrypted or unencrypted information associated with a particular card, issuer, creator, or group of merchants. It is also contemplated that the card may have multiple embodiments or forms. For example, the card may be a physical card (e.g., in the form of a magnetic striped plastic card), a virtual card (e.g., in the form of a display on a smart phone), or both. In embodiments in which the card is a virtual card, the corresponding account information (e.g., account number) would initially be provided to the consumer and the consumer would communicate the account information to the merchant. The virtual card may be communicated by displaying a display or screenshot, and/or by transmitting a signal, such as by using a near field communication (NFC) technology, or other secure transport technologies to complete the transaction with the selected merchant. NFC is a short range, high frequency, wireless communication technology that enables the exchange of data between devices over a relatively short distance. Optionally, the virtual card may have a display element (e.g., a barcode or string of numbers) which identifies the account number associated with the card. Alternatively, the virtual card may have display elements relating to the merchants that accept the card. Thus, whether the card is physical or virtual, the card may communicate account information.

A POS device of merchant 110 may provide transaction information to the payment network 120 using any desired payment transaction communications. When consumer 102 checks-out, or pays for the goods or services, the identifying indicia of consumer 102 may be used for authentication. In one or more embodiments, pin pad terminal 112 may include an NFC system 114. NFC system 114 may communicate wirelessly with payment vehicle 101 of consumer 102, for example to obtain an authorization code or identifying information of consumer 102 or of payment vehicle 101. In one or more embodiments, pin pad terminal 112 may include a keypad 116. Consumer 102 may enter a personal identification number on keypad 116 for making a payment. Other numbers or alphanumeric characters, such as temporary passwords or authorization codes, are also contemplated as would be understood by one of ordinary skill in the art. In one or more embodiments, pin pad terminal 112 may include a scanner 218. Consumer 102 may display a code, such as, for example, a barcode or quick response (QR) code, etc., on the display of their mobile computing device to provide identifying indicia of consumer 102. Scanner 218 may be, for example, a handheld scanner, an embedded scanner such as is used to scan items at grocery stores, a camera, and so forth as would be understood by one of ordinary skill in the art.

Pin pad terminal 112 may include a display area 122. In one or more embodiments the display area 122 may be, for example, a window, a widget, or a pop-up, a webpage, and so forth, and be rectangular or nonrectangular, and occupy one or multiple contiguous or non-contiguous areas of pin pad terminal 112.

Pin pad terminal 112 may generate a payment request for payment by merchant 110. The payment request may include information such as, for example, information identifying the merchant to acquirer processor 130 or the party of payment network 120, the payment amount, which can include a gratuity, identifying indicia for consumer 102, authentication information such as whether the consumer was authenticated by merchant 110 using images of consumer 102, and/or authentication information such as personal identification number entered on keypad 116 by the consumer, a code scanned by scanner 218, or information about consumer 102 or payment vehicle received via NFC handshake or any other suitable authentication information.

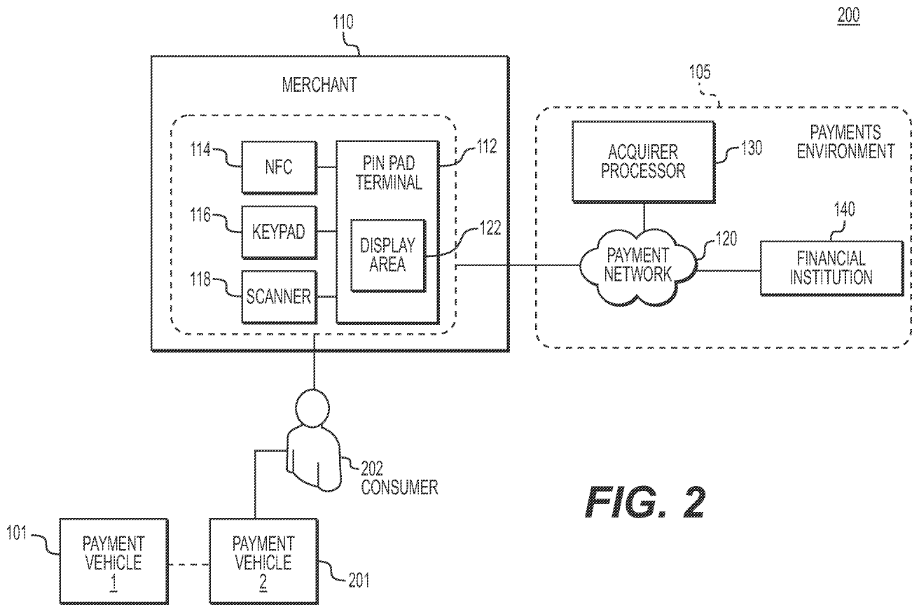

FIG. 2 depicts an alternative merchant environment for processing

consumer payment transactions, according to one or more embodiments. In FIG. 2, a second consumer 202 may use a secondary payment vehicle 201 to make purchases with merchant 110. As shown in FIG. 2, secondary payment vehicle 201 may be linked with payment vehicle 101. According to one or more embodiments to be described in detail below, secondary payment vehicle 201 may be established by a primary account holder for payment vehicle 101, such as consumer 102. In addition, the primary account holder may establish rules governing the use of secondary payment vehicle 201. Secondary payment vehicle 201 may be associated with the same financial account or other source of funds as payment vehicle 101, or secondary payment vehicle 201 may be associated with a different financial account or other source of funds than payment vehicle 101.

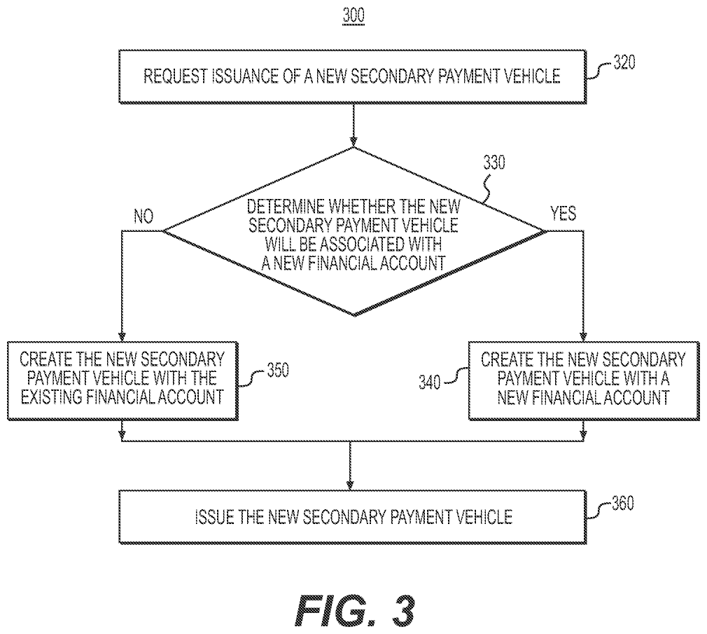

For example, FIG. 3 is a flowchart depicting an example process for creating a secondary payment vehicle, according to one or more embodiments. As shown in FIG. 3, in operation 320, a primary cardholder, such as consumer 102 depicted in FIG. 1, may request issuance of a new secondary payment vehicle, such as payment vehicle 201 depicted in FIG. 2. In operation 330, it may be determined whether the new secondary payment vehicle will be associated with an existing financial account or a new financial account. For example, the new secondary payment vehicle may be associated with a financial account that is already associated with a primary payment vehicle, such as payment vehicle 101 depicted in FIG. 1. That is, in operation 330, it may be determined whether the new secondary payment vehicle draws from the same source of funds as the primary payment vehicle. If the new secondary payment vehicle is to be associated with a new financial account, then at operation 340, the new secondary payment vehicle is created with a new financial account. If the new secondary payment vehicle is to be associated with an existing financial account, then at operation 350, the new secondary payment vehicle is created with the existing financial account. At operation 360, the new secondary payment vehicle may be issued.

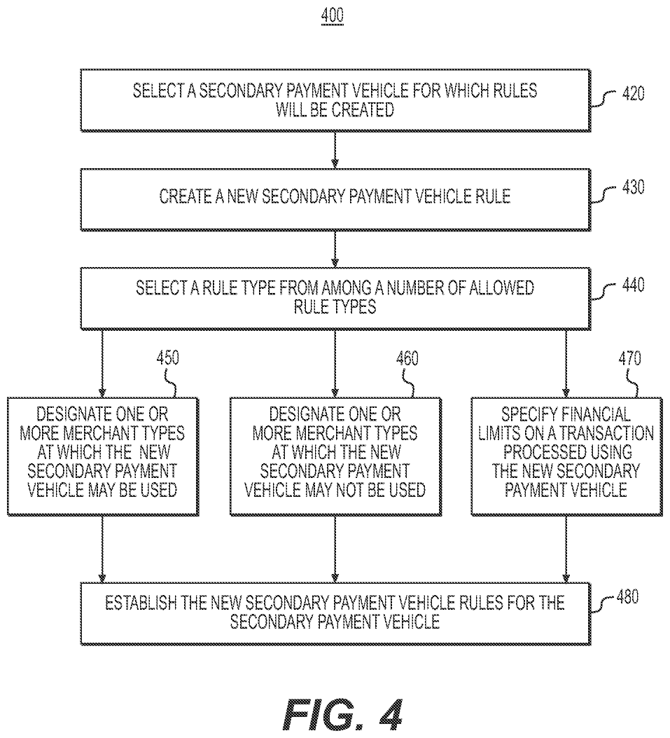

Once a secondary payment vehicle 201 has been issued, the primary account holder may wish to set rules concerning the use of the secondary payment vehicle. FIG. 4 is a flowchart depicting an example process for creating secondary payment vehicle rules, according to one or more embodiments. As shown in FIG. 4, at operation 420, the primary cardholder, such as consumer 102 depicted in FIG. 1, may select a secondary payment vehicle rule for which rules will be created. At operation 430, the primary cardholder may create a new secondary payment vehicle rule. At operation 440, the primary cardholder may select a rule type from among a number of allowed rule types. For example, at operation 450, the primary cardholder may designate one or more merchant types, according to a merchant category code (MCC) or any other designation associated with a merchant, at which the new secondary payment vehicle may be used. Alternatively, at operation 460, the primary cardholder may designate one or more merchant types at which the new secondary payment vehicle may not be used. In addition, at operation 470, the primary cardholder may specify financial limits on a transaction processed using the new secondary payment vehicle. The financial limits may include, for example, a limit on the number of transactions completed within a specified period of time or the “velocity” of use of the secondary payment vehicle. The “velocity” may refer to a number of transactions within the same day, hour, number of hours, number of minutes, or any other period of time. The financial limits may further include, for example, a limit on the maximum size of an individual transaction, such as a $100 maximum on a transaction processed using the new secondary payment vehicle. Alternatively, the financial limits may include a limit on the maximum cumulative size of a number of transactions within a specified period, such as a $500 limit on the total value of transactions completed within a single day. Furthermore, the limits on merchant types and financial limits may be combined such that financial limits are applied only to specified merchant types, such as a limit of $30 per transaction at a gas station, for example. Other rule types may be specified by the primary cardholder such as, for example, a limited geographic area within which the secondary payment vehicle may be used, a limited geographic area within which the secondary payment vehicle may not be used, calendar restrictions specifying particular days of the week, months of the year, or a range of dates during which use of the secondary payment vehicle may be permitted or restricted, or times of day during which the secondary payment vehicle may or may not be used, etc. After the primary cardholder has created one or more new secondary payment vehicle rules, at operation 480, the new secondary payment vehicle rules may be established for the secondary payment vehicle. In one embodiment, the financial limits 470 may be specified as a function of some characteristic, parameter, or status of the first payment vehicle 101 or the account and/or balance of the first payment vehicle 101, whether or not said account/balance is shared with the second payment vehicle 201. For example, the primary account holder (e.g., consumer 102) may specify that a transaction requested in relation to payment vehicle 201 may not be for an amount in excess of e.g., some percentage of remaining balance of the account of first payment vehicle 101. Alternatively, the primary account holder (e.g., consumer 102) may specify that a transaction requested in relation to payment vehicle 201 may not exceed a running average of transactions authorized in relation to the first payment vehicle 101. In addition, a transaction request in relation to payment vehicle 201 may be limited to the available balance for payment vehicle 201. Whether a to payment vehicle 201 has its own funding account or shares it with the primary card, if to payment vehicle 201 is a stored value card, such as a prepaid card, to payment vehicle 201 may be limited to its balance, in addition to other rules established for to payment vehicle 201.

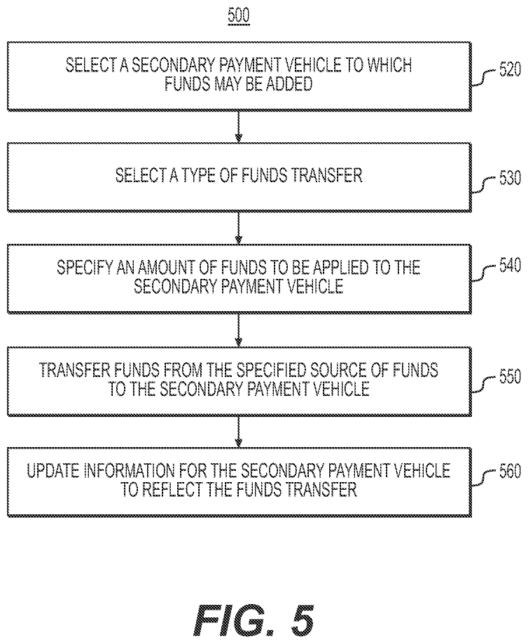

As discussed above, a secondary payment vehicle may be associated with the same financial account as another, primary, payment vehicle or may be associated with a separate financial account. Alternatively, a dedicated source of funds may be established for the secondary payment vehicle, such as, for example, if the secondary payment vehicle is a pre-paid payment card. In such a case, value may be added to the secondary payment vehicle by, for example, transferring funds from a primary payment vehicle to the secondary payment vehicle. FIG. 5 is a flowchart depicting an example process for adding funds to a secondary payment vehicle, according to one or more embodiments. As shown in FIG. 5, at operation 520, the primary cardholder, such as consumer 102 depicted in FIG. 1, may select a secondary payment vehicle to which funds may be added. At operation 530, the primary cardholder may select a type of funds transfer. For example, funds may be transferred from another payment vehicle, such as payment vehicle 101 depicted in FIG. 1. Alternatively, funds may be transferred from a financial account. At operation 540, the primary cardholder may specify an amount of funds to be applied to the secondary payment vehicle. At operation 550, funds may be transferred from the specified source of funds to the secondary payment vehicle. The transfer may be made to a dedicated source of funds associated with the secondary payment vehicle, such as for a pre-paid payment vehicle, or may be made to a financial account associated with the secondary payment vehicle. At operation 560, information for the secondary payment vehicle may be updated to reflect the funds transfer.

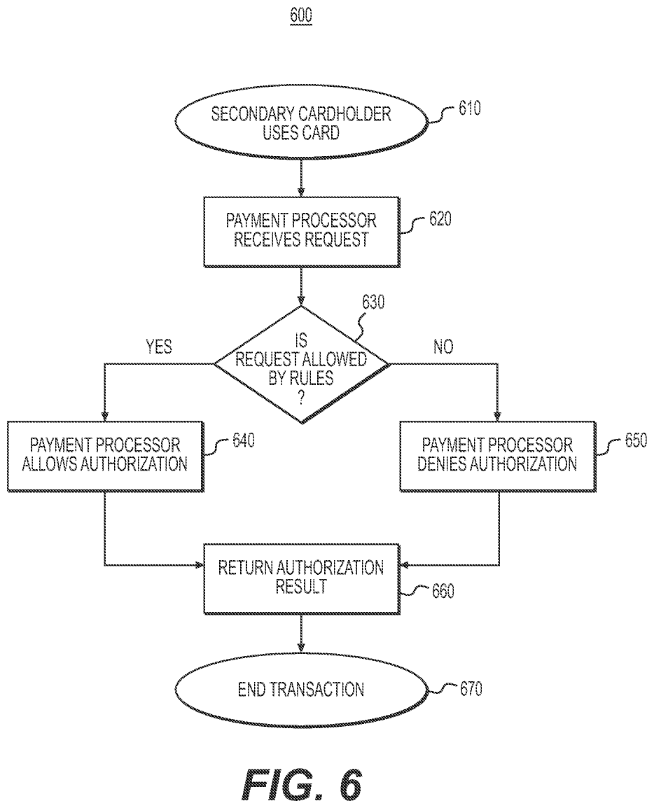

Once the secondary payment vehicle has been created, linked with a source of funds, and established with a set of rules restricting its use, the secondary payment vehicle may be used by an authorized user. Such use may be governed by the application of one or more rules, such as those that may be established by a process such as that disclosed in FIG. 5. FIG. 6 is a flowchart depicting an example process for applying secondary payment vehicle rules, according to one or more embodiments. As shown in FIG. 6, in operation 610, a payment processor, such as acquirer processor 130 depicted in FIG. 1, may receive a payment authorization request associated with a secondary payment vehicle from a requestor, such as pin pad terminal 112 associated with merchant 110 depicted in FIG. 1. At operation 620, the payment processor may determine whether the payment request is allowed by one or more rules associated with the secondary payment vehicle. For example, the payment processor may compare one or more data items for the payment authorization request -such as, for example, a transaction amount, a transaction date, a transaction time, an MCC for a merchant at which the transaction is to be conducted, a geographic area in which the transaction is to be conducted, a velocity of recent transactions for the secondary payment vehicle, etc.-to one or more rules established for the secondary payment vehicle. If the one or more data items do not match, rules established for the secondary payment vehicle or if the data items satisfy each matching rule for the secondary payment vehicle, then at operation 630, the payment processor may approve authorization of the payment authorization request. Otherwise, the payment processor may decline authorization of the payment authorization request in operation 640. At operation 650, the payment processor may return an authorization response to the requestor.

These and other embodiments of the systems and methods may be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc., are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc., can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures, or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

It is intended that the specification and examples be considered as exemplary only, with a true scope and spirit of the invention being indicated by the following claims.

1. A computer-implemented method for processing a payment authorization request using a merchant system, the method comprising:
receiving, by one or more processors and from a terminal associated with the merchant system, the payment authorization request of a consumer transaction, wherein the payment authorization request includes a plurality of transaction data captured by the merchant system;
determining, by the one or more processors, that the payment authorization request is associated with a secondary payment vehicle, and wherein the secondary payment vehicle is associated with a primary payment vehicle associated with a first account of a first entity, and wherein the secondary payment vehicle is associated with the first account of the first entity;
extracting, by the one or more processors, one or more transaction features from the plurality of transaction data;
generating, by the one or more processors, an authorization response message based on comparing the one or more transaction features to one or more secondary payment vehicle rules to determine that each of the one or more transaction features satisfies each of the one or more secondary payment vehicle rules, the one or more secondary payment vehicle rules of a first rule type among a plurality of allowed rule types, the plurality of allowed rule types including:
an allowed geographic area;
an allowed merchant type; and
an allowed transaction amount, based on a specified first set of financial limits, the specified first set of financial limits associated with a percentage of a remaining balance of the first account of the first entity and based on a specified second set of financial limits including an amount not to exceed a running average associated with transactions authorized for the primary payment vehicle within a specified period of time;
transmitting, by the one or more processors, the authorization response message to the terminal associated with the merchant system; and
in response to transmitting the authorization response message, outputting, by the terminal associated with the merchant system, a graphical representation of an authorization to a display of the terminal.

2. The computer-implemented method of claim 1, wherein the one or more secondary payment vehicle rules are of a second rule type, among the plurality of allowed rule types combined with the first rule type.

3. The computer-implemented method of claim 1, wherein the plurality of allowed rule types further includes specifying a third set of financial limits including a limit on a number of transactions completed within a specified period of time.

4. The computer-implemented method of claim 1, wherein the plurality of allowed rule types further includes specifying a fourth set of financial limits including a limit on a maximum size of an individual transaction.

5. The computer-implemented method of claim 1, wherein the plurality of allowed rule types further includes specifying a fifth set of financial limits including a limit on a maximum cumulative size of a number of transactions within a specified period of time.

6. The computer-implemented method of claim 1, wherein the plurality of allowed rule types further includes:
a second limited geographic area within which the secondary payment vehicle may be used;
specified days of a week, months of a year, or a range of dates during which a use of the secondary payment vehicle may be permitted or restricted; and
specified times of day during which the use of the secondary payment vehicle may be permitted or restricted.

7. A computer-implemented method for processing a payment authorization request using a merchant system, the method comprising:
creating, by one or more processors and based on a first request from a first entity associated with a primary payment vehicle associated with a first account of the first entity, a secondary payment vehicle associated with a second entity, wherein the secondary payment vehicle is associated with the first account of the first entity;
receiving, by the one or more processors and from a terminal associated with the merchant system, the payment authorization request associated with a consumer transaction associated with the secondary payment vehicle, wherein the payment authorization request includes a plurality of transaction data captured by the merchant system;
extracting, by the one or more processors, one or more transaction features from the plurality of transaction data;
generating, by the one or more processors, an authorization response message based on determining that the payment authorization request is allowed by one or more rules associated with the secondary payment vehicle, by comparing the plurality of transaction data to the one or more rules associated with the secondary payment vehicle;
transmitting, by the one or more processors and to a user device associated with the merchant system, the authorization response message; and
in response to transmitting the authorization response message, outputting, by the terminal associated with the merchant system, a graphical representation of an authorization to a display of the terminal;
wherein the one or more rules associated with the secondary payment vehicle has a first rule type from among a plurality of allowed rule types, the plurality of allowed rule types including:
designating a limited geographic area within which the secondary payment vehicle may not be used;
designating one or more first merchant types at which the secondary payment vehicle may be used;
designating one or more second merchant types at which the secondary payment vehicle may not be used;
specifying a first set of financial limits on a transaction to be processed using the secondary payment vehicle, wherein the transaction to be processed using the secondary payment vehicle may not be for an amount in excess of a percentage of a remaining balance of the first account associated with the first entity; and
specifying a second set of financial limits on the transaction to be processed using the secondary payment vehicle, wherein a first monetary amount of the transaction to be processed using the secondary payment vehicle may not exceed a running average of a second monetary amount of transactions authorized in relation to the primary payment vehicle.

8. (canceled)

9. The computer-implemented method of claim 7, wherein the plurality of allowed rule types further includes specifying a third set of financial limits including a limit on a number of transactions completed within a specified period of time.

10. The computer-implemented method of claim 7, wherein the plurality of allowed rule types further includes specifying a fourth set of financial limits including a limit on a maximum size of an individual transaction.

11. The computer-implemented method of claim 7, wherein the plurality of allowed rule types further includes specifying a fifth set of financial limits including a limit on a maximum cumulative size of a number of transactions within a specified period of time.

12. The computer-implemented method of claim 7, wherein the plurality of allowed rule types further includes:
a second limited geographic area within which the secondary payment vehicle may be used;
specified days of a week, months of a year, or a range of dates during which a use of the secondary payment vehicle may be permitted or restricted; and
specified times of day during which the use of the secondary payment vehicle may be permitted or restricted.

13. The computer-implemented method of claim 7, wherein the one or more rules is of a second rule type, among the plurality of allowed rule types, combined with the first rule type.

14. A computing system comprising:
a memory having processor-readable instructions stored therein; and
one or more processors configured to access the memory and execute the processor-readable instructions to perform a method for processing a payment authorization request, the method comprising:
creating, by one or more processors and based on a first request from a first entity associated with a primary payment vehicle associated with a first account of the first entity, a secondary payment vehicle associated with a second entity, wherein the secondary payment vehicle is associated with the first account of the first entity;
receiving, by the one or more processors and from a terminal associated with a merchant system, the payment authorization request associated with a consumer transaction associated with the secondary payment vehicle, wherein the payment authorization request includes a plurality of transaction data captured by the merchant system;
extracting, by the one or more processors, one or more transaction features from the plurality of transaction data;
generating, by the one or more processors, an authorization response message based on determining that the payment authorization request is allowed by one or more rules associated with the secondary payment vehicle, by comparing the plurality of transaction data to the one or more rules associated with the secondary payment vehicle;
transmitting, by the one or more processors and to a user device associated with the merchant system, the authorization response message; and
in response to transmitting the authorization response message, outputting, by the terminal associated with the merchant system, a graphical representation of an authorization to a display of the terminal;
wherein the one or more rules associated with the secondary payment vehicle has a first rule type from among a plurality of allowed rule types, the plurality of allowed rule types including:
designating a limited geographic area within which the secondary payment vehicle may not be used;
designating one or more first merchant types at which the secondary payment vehicle may be used;
designating one or more second merchant types at which the secondary payment vehicle may not be used;
specifying a first set of financial limits on a transaction to be processed using the secondary payment vehicle, wherein the transaction to be processed using the secondary payment vehicle may not be for an amount in excess of a percentage of a remaining balance of the first account associated with the first entity; and
specifying a second set of financial limits on the transaction to be processed using the secondary payment vehicle, wherein a first monetary amount of the transaction to be processed using the secondary payment vehicle may not exceed a running average of a second monetary amount of transactions authorized in relation to the primary payment vehicle.

15. (canceled)

16. The computing system of claim 14, wherein the plurality of allowed rule types further includes specifying a third set of financial limits including a limit on a number of transactions completed within a specified period of time.

17. The computing system of claim 14, wherein the plurality of allowed rule types further includes specifying a fourth set of financial limits including a limit on a maximum size of an individual transaction.

18. The computing system of claim 14, wherein the plurality of allowed rule types further includes specifying a fifth set of financial limits including a limit on a maximum cumulative size of a number of transactions within a specified period of time.

19. The computing system of claim 14, wherein the plurality of allowed rule types further includes:
a second limited geographic area within which the secondary payment vehicle may be used;
specified days of a week, months of a year, or a range of dates during which a use of the secondary payment vehicle may be permitted or restricted; and
specified times of day during which the use of the secondary payment vehicle may be permitted or restricted.

20. The computing system of claim 14, wherein the one or more rules is of a second rule type, among the plurality of allowed rule types, combined with the first rule type.
